(19) United States
(12) Patent Application Publication
(10) Pub. No.: US 2003/0078844 A1
(43) Pub. Date: Apr. 24, 2003

(54) Charging system

(76) Inventors: Sunao Takatori, Tokyo (JP); Hisanori Kiyomatsu, Tokyo (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/088,878

(22) PCT Filed: Mar. 30, 2001
(86) PCT No.: PCT/JP00/02774

(51) Int. Cl. G06F 17/60

(52) U.S. Cl. 705/17; 705/16

(57) ABSTRACT

A portable terminal device (1) at least transmits a customer ID of a user and billing account information of any billing account of a plurality of billing accounts; the user is identified by the customer ID transmitted from the portable terminal device (1) based on a customer ID of the user and plural pieces of billing account information related to the customer ID, which are previously stored in a customer database (41) of a control server (3); a billing account to which a cost is charged is determined from among the plurality of accounts opened by the identified user by the billing account information transmitted from the portable terminal device (1). Thereby, a cost for goods or service can be charged to a desired account among the plurality of accounts.

### TECHNICAL FIELD

The present invention relates to a charging system, a charging method, and a portable device and a control server used therein, for charging a cost for goods or service to an account opened by a user.

### BACKGROUND ART

For example, in credit settlement and the like, when a cost for goods or service is charged to an account opened by a user, it is charged to a single account in general.

On the other hand, due to diversification of consuming activity of customers, the case where one customer opens a plurality of payment accounts for each purpose is increasing. For example, some open separate payment accounts for paying home expenses such as heating and electricity bills and the like and for paying private expenses, and in some cases further open another payment account for paying business expenses.

In addition, in portable telephone service, costs such as telephone call charges are generally charged to a single account. On the other hand, PHS (Personal Handyphone System) service has separate charge account service in which two billing accounts can be used. The separate charge account service is service in which either of billing accounts for main or sub count is selected and thereafter a call is made so that the charge for the call is charged to the selected billing account.

In addition to telephone call service, such portable telephone service provides data communication such as browsing websites and receiving/sending electronic mails by connecting to the Internet, and the communication fees thereof are also charged to the billing account of the telephone call charges.

However, if a user tries to use separate billing accounts in accordance with purpose, for example, the user has to have totally two credit cards specialized for each purpose.

Further, if a user tries to make the telephone call charges to be charged to separate accounts, for example, for business and for private purpose, the user needs to select a billing account at every call in accordance with a call destination as described above, which is inconvenient.

Furthermore, as described above, in addition to the telephone call service, data communication and the like are possible with the mobile telephone but it is difficult to charge to separate accounts by each service.

This invention is made to solve the above-described problems and its object is to obtain a charging system, a charging method, a portable device, and a control server allowing a cost for goods or service to be charged to a desired account among a plurality of accounts.

### DISCLOSURE OF THE INVENTION

A charging system according to the present invention comprises a portable device at least storing an identifier of a user and outputting billing account information of any billing account of a plurality of billing accounts, and a control server having a storage means for storing the identifier of the user and plural pieces of billing account information corresponding to the identifier and a charging means for identifying the user by the identifier obtained from the portable device and determining a billing account to which a cost is charged by the billing account information obtained from the portable device.

Using this charging system, it is possible to charge a cost for goods or service to a desired account among the plurality of accounts.

Moreover, in addition to the above-described charging system of the invention, the charging system according to the present invention comprises a terminal device receiving the identifier and the billing account information from the portable device and transmitting them to the control server, and the terminal device transmits to the control server a charging amount to the user together with the identifier and the billing account information, and the control server charges the charging amount to the determined billing account to be charged.

Using this charging system, and if an existing communication channel from the terminal device to the control server is used, it is also possible to realize a system at a low cost. In addition, the user need not input the charging amount and so on.

Further, in addition to the above-described charging systems of the invention, the charging system according to the present invention utilizes a portable terminal device as a portable device, and the portable terminal device comprises a portable device side storage means for storing the identifier of the user, a display means for displaying a list of the billing accounts based on the plural pieces of billing account information stored in the portable device side storage means, an input means for receiving operation of the user, a selection means for selecting any of the plurality of billing accounts in response to the operation of the user to the input means, and an output means for outputting the billing account information of the billing account selected by the selection means.

Using this charging system, it is also possible for the user to confirm an account to be charged in a visual manner, lower the possibility to make an error in selecting the account to be charged, and simplify the operation of selecting the account.

Further, in addition to the above-described charging systems of the invention, the portable device side storage means of the portable device in the charging system according to the present invention stores the plural pieces of billing account information of the plurality of billing accounts owned by the user.

Using this charging system, the plural pieces of the billing account information are read out from the portable device side storage means, which further enables quick display of the list of the billing accounts.

Furthermore, in addition to the above-described charging systems of the invention, the control server in the charging system according to the present invention transmits to the portable device the plural pieces of billing account information corresponding to the identifier of the user which is stored in the storage means, and the display means of the portable device displays the list of the billing accounts based on the plural pieces of billing account information which are transmitted from the control server.

Using this charging system, the portable device need not store the plural pieces of billing account information therein, which makes it also possible to reduce the cost of the portable device.

Moreover, in addition to the above-described charging systems of the invention, the charging system according to the present invention utilizes a card as a portable device, and the card stores the identifier of the user and billing account information of any billing account of the plurality of billing accounts, in which the billing account information is rewritable and the identifier of the user and the billing account information are readable.

Using this charging system, billing account information in accordance with purpose is stored in the card in advance, and thus, payment can be also easily performed at a shop and the like.

Further, in addition to the above-described charging systems of the invention, the charging system according to the present invention utilizes the card as the portable device, the card stores the identifier of the user, in which the billing account information is rewritable and the identifier of the user is readable, the control server transmits to the terminal device the plural pieces of billing account information corresponding to the identifier of the user which is stored in the storage means, and the terminal device displays the list of the billing accounts based on the plural pieces of billing account information which are transmitted from the control server, selects any the plurality of billing accounts in response to the operation by the user, and transmits the selected billing account information to the control server.

By using this charging system, the portable device need not store the billing account information therein, which makes it also possible to reduce the cost of the card as a portable device.

Furthermore, in addition to the above-described charging systems of the invention, the control server in the charging system according to the present invention regards a predetermined billing account as an account to be charged when a billing account is not specified.

By using this charging system, if an account which is to be mainly used is determined, it is also possible to omit the selecting operation for charging to the account, which improves the convenience of the users.

Moreover, in addition to the above-described charging systems of the invention, the portable device in the charging system according to the present invention stores corresponding relation between a type of goods and/or service to be purchased by the user and any billing account information, and outputs billing account information having corresponding relation with goods/or service when the goods and/or service is purchased and a cost is incurred by the user.

By using this charging system, if the user operates the portable device to select goods or service to purchase, it is also possible to eliminate the necessity for the user to remember which goods or service is charged to which account and reduce the possibility to make an error in selecting the account to be charged.

Further, in addition to the above-described charging systems of the invention, the charging system according to the present invention utilizes a mobile telephone as a portable device, the mobile telephone classifies and stores a plurality of destination telephone numbers, and, when a telephone call is made, outputs information of a group to which a destination telephone number of the telephone call belongs as a billing account information, and the storage means of the control server stores the telephone number of the portable device as the identifier of the user as well as stores the plural pieces of billing account information corresponding to the user which relate to the groups to which destination telephone numbers belong, and the charging means of the control server identifies the user from the telephone number of the portable device when a telephone call is made by the portable device, and determines a billing account to charge the telephone call charge for the call, based on the billing account information transmitted from the portable device, which corresponds to the group to which the destination telephone number of the call belongs.

Using this charging system, it is also possible to charge the telephone call charge of the mobile telephone as a portable device to a billing account in accordance with the call destination automatically.

Furthermore, a charging method according to the present invention comprises a step where the portable device transmits the identifier of the user and the billing account information of any billing account of the plurality of billing accounts, and a step of identifying the user by the identifier transmitted from the portable device, based on the identifier of the user and the plural pieces of billing account information related to the identifier which are previously stored in the customer database in the control server, and determining a billing account to be charged from among the plurality of billing accounts opened by the identified user.

Using this charging method, it is possible to charge a cost for goods or service to a desired account among the plurality of accounts.

The portable device in the present invention comprises the portable device side storage means for at least storing the identifier of the user, and the output means for outputting the billing account information of any billing account of the plurality of billing accounts opened by the user.

By using the portable device, it is possible to charge a cost for goods or service to a desired account among the plurality of accounts in the charging system when user operates the portable device.

The control server in the present invention comprises the storage means for storing the identifier of the user who opens an account to charge a cost and the plural pieces of billing account information corresponding to the identifier, and the charging means for identifying the user by the identifier obtained from the portable device of the user, with reference to the identifier of the user and its plural pieces of billing account information in the storage means, and determining a billing account to be charged by the billing account information obtained from the portable device of the user.

By using the control server, it is possible to charge a cost for goods or service to a desired account among the plurality of accounts in the charging system.

The charging system according to the present invention comprises a mobile telephone storing the plurality of destination telephone numbers and the plural pieces of billing account information of the plurality of billing accounts opened by the user, by relating each destination telephone number to any of the billing account information, and, when a telephone call is made, outputting billing account information related to the telephone number of the calling destination, and a control server determining a billing account to be charged by the billing account information obtained from the mobile telephone.

By using the charging system, it is possible to charge a telephone call charge of the mobile telephone to a desired account among the plurality of accounts. In addition, since the billing account information is stored in the mobile telephone, the user can edit the billing account information easily by operating the mobile telephone freely.

The charging system according to the present invention comprises a mobile telephone classifying and storing the plurality of destination telephone numbers, relating the billing accounts opened by the user to a plurality of groups respectively, storing the plural pieces of billing account information of the plurality of billing accounts, and, when a call is made, outputting the billing account information of the billing account related to the group to which the telephone number of the calling destination belongs, and a control server determining a billing account to be charged by the billing account information obtained from the mobile telephone.

Using the charging system, it is possible to charge a telephone call charge of the mobile telephone to a desired account among a plurality of accounts. In addition, as the billing account information is stored in the mobile telephone, the user can edit the billing account information easily by operating the mobile telephone freely. Moreover, since the billing account information is related to the group of the destination telephone number, the charging destinations are separated based on groups which are easy for the user to recognize, such as business and private.

### BRIEF DESCRIPTION OF THE DRAWINGS

FIG. 1 is a block diagram showing the structure of a charging system according to the first embodiment of the present invention;

FIG. 2 is a block diagram showing the structure of a portable terminal device in FIG. 1;

FIG. 3 is a block diagram showing the structure of a control server in FIG. 1;

FIG. 4 is a chart showing one example of a customer database included in the control server in FIG. 1;

FIG. 5 is a block diagram showing the structure of a charging system according to the second embodiment of the present invention; and

FIG. 6 is a block diagram showing the structure of a charging system according to the third embodiment of the present invention.

### BEST MODE FOR CARRYING OUT THE INVENTION

The preferred embodiments of the present invention are explained below with reference to the drawings.

First Embodiment

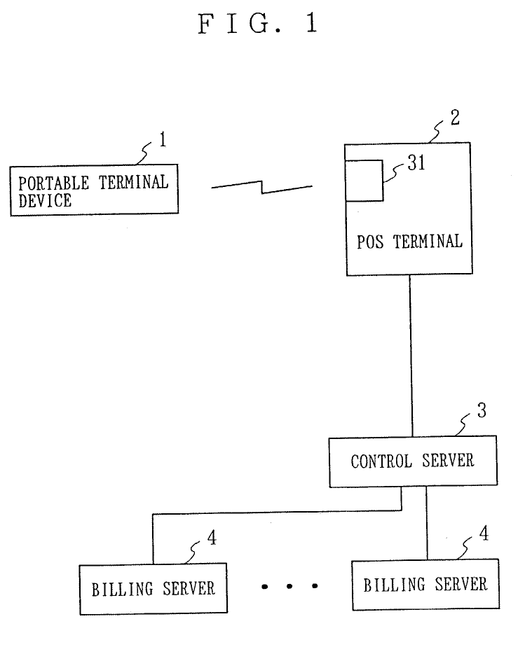

FIG. 1 is a block diagram showing the structure of a charging system according to the first embodiment of the present invention.

In FIG. 1, a portable terminal device 1 is a portable device such as a mobile telephone and a PDA (Personal Digital Assistant) at least storing a customer ID which is an identifier of a user, and outputting the billing account information of any billing account of a plurality of billing accounts opened by the user, for each user of the charging system.

The customer ID of the user may be stored in a ROM (Read Only Memory) so as not to be modifiable while the billing account information may be stored in a nonvolatile RAM (Random Access Memory) or EEPROM (Electric Erasable Programmable ROM) or the like so as to be modifiable. In addition, the billing account information inputted by the user with operation of the portable terminal device 1 may be stored, or what was supplied from an outer device (not shown) may be stored.

Further, a POS terminal 2 is a terminal device installed in various shops, which has a register function of reading a barcode and the like provided on goods and the like and performing the settlement of the goods and the like, and performs transmission/receiving of information of goods and the like to/from a center (not shown) and the like. The POS terminal 2 is also a terminal device receiving the customer ID and the billing account information transmitted from the portable terminal device 1 by a receive circuit 31, and transmitting to a control server 3 a charging amount to the user together with the information.

Further, the control server 3 is a server device identifying the user by the customer ID obtained from the portable terminal device 1, determining a billing account to which a cost is charged by the billing account information obtained from the portable terminal device 1, and charging the charging amount from the POS terminal 2 to the billing account to be charged, managed by any of billing servers 4.

Incidentally, the POS terminal 2 and the control server 3 may be connected with a leased line, or a line for CAT (Credit Authorization Terminal) system which is used for credit settlement.

In addition, the billing server 4 is a server device managing billing account information of a customer (user). The billing server 4 may be one server managing plural pieces of billing account information corresponding to a customer, or there may be a plurality of the billing servers 4 as shown in FIG. 1. For example, each of the billing servers 4 may be owned by a respective financial institution and each financial institution may manage an account which a customer opens therein. Furthermore, the control server 3 and the billing server 4 may be realized as one server device. Incidentally, security of a communication channel is secured with a leased line and the like between the control server 3 and the billing server 4.

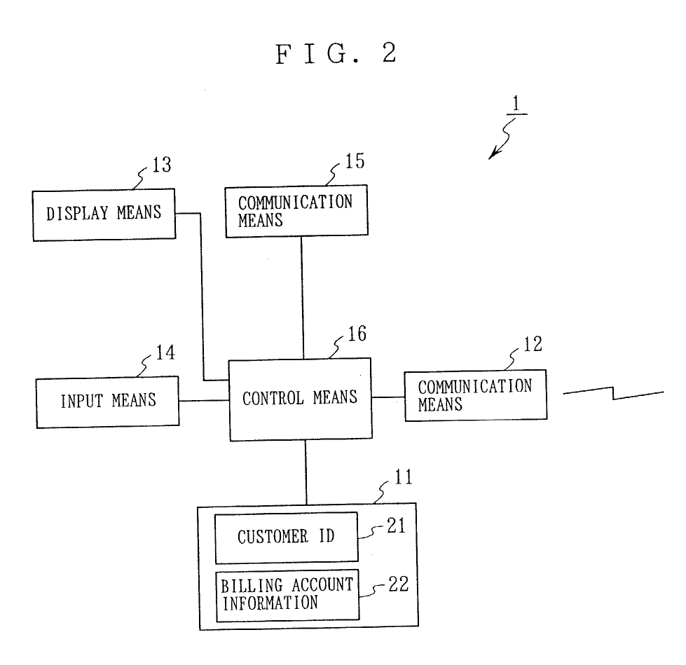

FIG. 2 is a block diagram showing the structure of the portable terminal device 1 in FIG. 1.

In FIG. 2, a portable device side storage means 11 is a nonvolatile memory storing the customer ID 21 which is an identifier of the user and the plural pieces of billing account information 22 of the plurality of billing accounts owned by the user.

Further, a communication means 12 is a circuit working as an output means for outputting to the POS terminal 2 the identifier of the user stored in the portable device side storage means 11 and the billing account information of the billing account selected based on the operation of the user. Incidentally, as communication form from the portable terminal device 1 to the POS terminal 2, wireless communication using radio waves, infrared rays, and so on, may be utilized, or a cable communication may be utilized after the portable terminal device 1 is connected or in contact to the POS terminal 2. Moreover, as the wireless communication in this case, Bluetooth technology may be also utilized.

In addition, a display means 13 is a device such as a liquid crystal display, displaying various information as well as a list of the billing accounts based on the plural pieces of billing account information 22 stored in the portable device side storage means 11.

An input means 14 is a device which receives the operation of the user, such as an arrow key, a numeric key, and a tablet which senses pressure caused by handwriting and the like.

A communication means 15 is a sending/receiving circuit performing transmission/reception of voice signals and various data via a mobile telephone network. Incidentally, the communication means 15 is not particularly necessary in the first embodiment.

A control means 16 is a control circuit controlling each portion to realize an original function of the portable terminal device 1 (for example, a mobile telephone function or a function as a personal computer), and a circuit working as a selection means for selecting any of the plurality of billing accounts in response to the operation of the user to the input means 14. Incidentally, the control means 16 may be realized as hardware, or as a program with such a function described therein and a CPU to execute the program, that is, software.

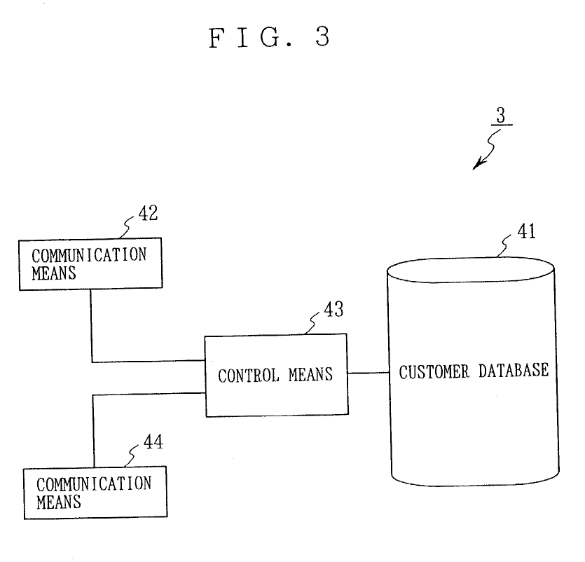

FIG. 3 is a block diagram showing the structure of the control server 3 in FIG. 1.

In FIG. 3, a customer database 41 is a database as a storage means for relating a customer ID of each user to information of one or a plurality of billing accounts opened by the user, and storing them.

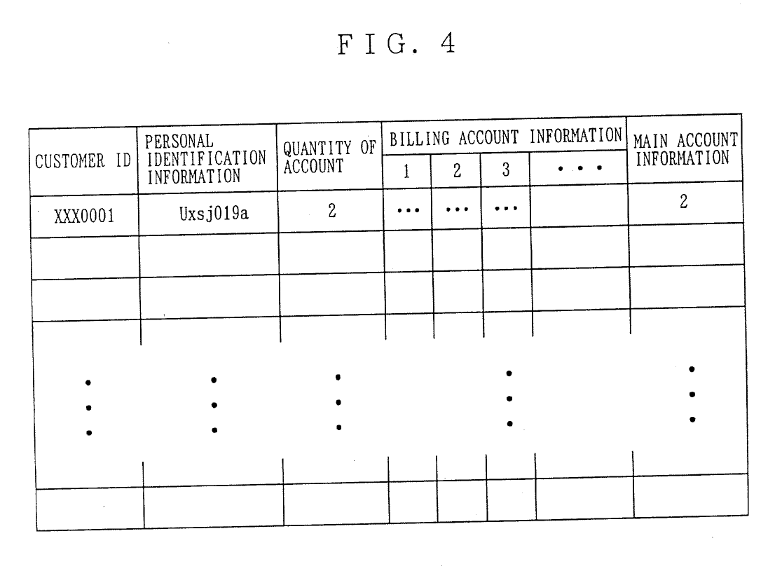

FIG. 4 is a chart showing one example of the customer database 41 in the control server 3. A customer ID is assigned to each user in advance. In addition, personal identification information can be set to authenticate a user at the time of charging, and a customer ID and personal identification information are stored for each customer in the customer database 41 as shown in FIG. 4.

Furthermore, related to a customer ID of each user, information of one or a plurality of billing accounts opened by the user (a name and the number of a financial institution, a name of a store such as head office or branch and a store number, a type of the account, the account number and so on), the number of the billing accounts, main account information designating an account to be charged (hereinafter referred to as a main account) when an account to be charged is not specified from among registered accounts, and so on, are stored as shown in FIG. 4.

For example, in a case shown in FIG. 4, ‘XXX0001’ is registered as a customer ID for some user and personal identification information ‘Uxsj019a’ is set for the customer ID. In addition, two pieces of billing account information are registered and the account of the second billing account information is set as a main account.

Getting back to FIG. 3, a communication means 42 is a circuit receiving the customer ID of the user, the billing account information, and the charging amount from the POS terminal 2.

Further, a control means 43 is a circuit working as a charging means for searching customer IDs which are registered in the customer database 41, identifying the user by the customer ID which is obtained from the portable terminal device 1 via the POS terminal 2, and determining a billing account to be charged from among the accounts opened by the user, by the billing account information which is obtained from the portable terminal device 1 via the POS terminal 2. Incidentally, the control means 43 may be realized as hardware, or as a program with such a function described therein and a CPU to execute the program, that is, software.

Moreover, a communication means 44 is a circuit transmitting the billing account information and the charging amount to the billing server 4 which includes the billing account to be charged.

Next, operation of each device in the above-described charging system is explained. In other words, a charging method according to the first embodiment of the present invention is explained.

When a user of the portable terminal device 1 purchases goods or the like at a shop and the like, the user first performs a predetermined operation to the input means 14 of the portable terminal device 1.

The control means 16 of the portable terminal device 1 receives from the input means 14 a signal responding to the predetermined operation by the user, and then it reads out the billing account information 22 of the accounts which can be specified as an account to be charged, stored in the portable device side storage means 11, and displays the list of the accounts on the display means 13.

The user operates the input means 14 to select a billing account to charge the purchasing cost for this time from the list of the accounts. Incidentally, in this event, if personal identification information is previously set to the customer ID of the user, the input means 14 is operated also to input the personal identification information thereto.

The control means 16 receives from the input means 14 a signal responding to the operation of selecting the account by the user, and then it reads out the billing account information 22 corresponding to the account selected by the user from the list of the accounts which is displayed on the display means 13.

Then, the control means 16 of the personal terminal device 1 also reads out the customer ID 21 of the user from the portable device side storage means 11, and controls the communication means 12 to transmit to the POS terminal 2 the customer ID 21 and the billing account information 22 of the account to be charged. Incidentally, if the personal identification information is inputted, the personal identification information is also transmitted.

The receive circuit 31 of the POS terminal 2 receives the customer ID and the billing account information from the portable terminal device 1. In addition, in the POS terminal 2, a cost to be charged to the user is calculated in the same manner as a conventional POS. The POS terminal 2 regards a part or the entire of the cost as a charging amount in accordance with request from the user, and transmits the charging amount to the control server 3 together with the customer ID and the billing account information which are received from the portable terminal device 1. Incidentally, if the personal identification information is also received from the portable terminal device 1, the POS terminal 2 also transmits the personal identification information to the control server 3 together with the information.

The communication means 42 of the control server 3 receives the customer ID, the billing account information and the charging amount from the POS terminal 2, and then it supplies them to the control means 43. The control means 43 first searches a large number of customer IDs registered in the customer database 41 to find the transmitted customer ID.

When the customer ID is found in the customer database 41, the control means 43 then searches one or the plural pieces of billing account information registered corresponding to the customer ID to find the transmitted billing account information.

In the case that the personal identification information is also received from the POS terminal 2, the control means 43 compares personal identification information registered corresponding to the customer ID with the transmitted personal identification information, and if both are identical, it tries to find the billing account information.

When the billing account information is found in the customer database 41, the control means 43 determines an account designated by the billing account information as a billing account for this time.

Then, the control means 43 of the control server 3 controls the communication means 44 to transmit the billing account information and the charging amount to the billing server 4 which includes the billing account for this time. The billing server 4 receives the billing account information and the charging amount from the control server 3, then, it performs charging processing to the account designated by the billing account information with regard to the amount designated by the charging amount. Incidentally, the charging amount to each billing account may be summarized and charged collectively, for example, by each month.

Meanwhile, if the customer ID cannot be found in the customer database 41, or if both pieces of the personal identification information are not identical, or if both pieces of the billing account information are not identical, the charging processing is not performed and, for example, an error message is transmitted from the control server 3 to the POS terminal 2 or to the personal terminal device 1 via the POS terminal 2.

In the above-described way, the portable terminal device 1 at least transmits the customer ID of the user and the billing account information of any billing account of the plurality of billing accounts; the user is identified by the customer ID transmitted from the portable terminal device 1, based on the customer ID of the user and the plural pieces of billing account information related to the customer ID, which are stored in advance in the customer database 41 of the control server 3; a billing account to be charged is determined from among the plurality of billing accounts opened by the identified user, by the billing account information transmitted from the portable terminal device 1.

When the user desires to charge to the main account, the user performs a predetermined operation to the portable terminal device 1. In response to the operation, the portable terminal device 1 transmits only the customer ID (or the customer ID and the inputted personal identification information) without displaying the list of the accounts to which a cost can be charged. The POS terminal 2 adds the charging amount to the information received from the portable terminal device 1 and transmits them to the control server 3. If the billing account information is not included in the transmitted information, the control server 3 reads out the main account information which is previously registered in the customer database 41, and determines a billing account to be charged based on the billing account information designated by the main account information.

As a result, if the user desires to charge to the main account, operation of selecting the account is unnecessary, which improves the convenience of the users.

The portable terminal device 1 transmits the customer ID and the like to the POS terminal 2, and the POS terminal 2 adds the charging amount to the received information and transfers them to the control server 3 in the above-described first embodiment, but it is also possible that the portable terminal device 1 connects with a terminal device or a server which opens an online shop via the Internet or the like, and transmits the customer ID and the like to the terminal device or the server after the security of the communication channel is secured with cryptographic technology and the like, and the terminal device or the server regards a cost for purchase at the online shop as a charging amount and transfers them to the control server 3.

Moreover, the billing account to be charged is selected based on the selecting operation of the user in the above-described first embodiment, but it is also suitable that the portable terminal device 1 stores previously the corresponding relation between the type of goods or service (for example, pay service on WWW, service provided in a particular shop, and so on) to be purchased by the user and information of any billing account and, when the user purchases the goods or service and a charge is incurred, billing account information having the corresponding relation with the goods or service is selected and transmitted.

In this case, it is possible that the portable terminal device 1 makes the display means 13 display the list of the goods or service and selects goods or service for this time from the list based on the selecting operation of the user, and selects the billing accounting information related to the selected goods or service. In addition, for example, if the service can be specified from a program or the like, such as electronic mail and the like, which is used in the portable terminal device 1, the billing account information related to the service may be automatically selected without display of the list.

As a result, if the user operates the portable terminal device 1 to select goods or service to purchase, the user need not remember which goods or service is charged to which account, which minimizes the possibility of making an error in selecting the billing account to be charged.

Furthermore, in the above-described first embodiment, the plural pieces of billing account information are stored in the portable device side storage means 11 of the portable terminal device 1, but it is also suitable that the control server 3 transmits the plural pieces of billing account information corresponding to the customer ID of the user of the portable terminal device 1, which are stored in the customer database 41, to the portable terminal device 1 via the POS terminal 2, the communication means 12 of the portable terminal device 1 receives the plural pieces of billing account information, and the control means 16 makes the display means 13 display the list of the billing accounts based on the plural pieces of billing account information.

As a result, it becomes unnecessary to store the plural pieces of billing account information in the portable terminal device 1, and thus, the storage capacity of the portable device side storage means 11 can be made small and the cost of the portable terminal device 1 can be reduced.

As described above, according to the first embodiment, the portable terminal device 1 at least stores the customer ID 21 of the user and outputs the billing account information 22 of any billing account of the plurality of billing accounts; the control server 3 includes the customer database 41 storing the customer ID of the user and the plural pieces of billing account information corresponding to the customer ID, and the control means 43 for identifying the user by the customer ID obtained from the portable terminal device 1 and determining a billing account to be charged by the billing account information obtained from the portable terminal device 1. As a result, a cost for goods or service can be charged to a desired account among the plurality of accounts.

Further, according to the above-described first embodiment, the POS terminal 2 is comprised which receives the customer ID and the billing account information from the portable terminal device 1 and transmits them to the control server 3; the POS terminal 2 transmits the charging amount to the user together with the customer ID of the user and the billing account information to the control server 3; the control server 3 charges the charging amount to the determined billing account to be charged. As a result, if the existing communication channel from the POS terminal 2 to the control server 3 is used, it is also possible to realize the system at a low cost. In addition, the user need not input the charging amount, and so on.

Further, according to the above-described first embodiment, the portable terminal device 1 includes the portable device side storage means 11 for storing the customer ID 21 of the user and the plural pieces of billing account information 22 of the plurality of billing accounts owned by user, the display means 13 for displaying the list of the billing accounts based on the plural pieces of billing account information stored in the portable device side storage means 11, the input means 14 for receiving the operation of the user, the control means 16 for selecting any of the plurality of billing accounts in response to the operation of the user to the input means 14, and the communication means 12 for outputting the billing account information of the billing account selected by the control means 16. As a result, the user can also confirm a billing account to be charged easily in a visual manner, which lowers the possibility to select a wrong billing account and simplifies the operation of selecting the account.

Furthermore, according to the above-described first embodiment, if the plural pieces of billing account information 22 of the plurality of billing accounts owned by the user are stored in the portable device side storage means 11 of the portable terminal device 1, the plural pieces of billing account information are read out from the portable device side storage means 11, which enables quick display of the list of the billing accounts.

Moreover, according to the above-described first embodiment, the control server 3 regards the main account as an account to be charged when a billing account is not specified. As a result, if an account to be mainly used is determined, and the account is made to be a main account, the selecting operation can be omitted when charging to the account, which improves the user's convenience.

In addition, according to the above-described first embodiment, the portable terminal device 1 stores the corresponding relation between the type of goods and/or service to be purchased by the user and any billing account information, and when the user purchases the goods and/or service and a cost is incurred by the user, the portable terminal device 1 outputs billing account information which has corresponding relation with the goods and/or service. As a result, if the user operates the portable terminal device 1 to select goods or service to purchase, the user need not remember which goods or service is charged to which account, which minimizes the possibility of making an error in selecting a billing account to be charged.

Second Embodiment

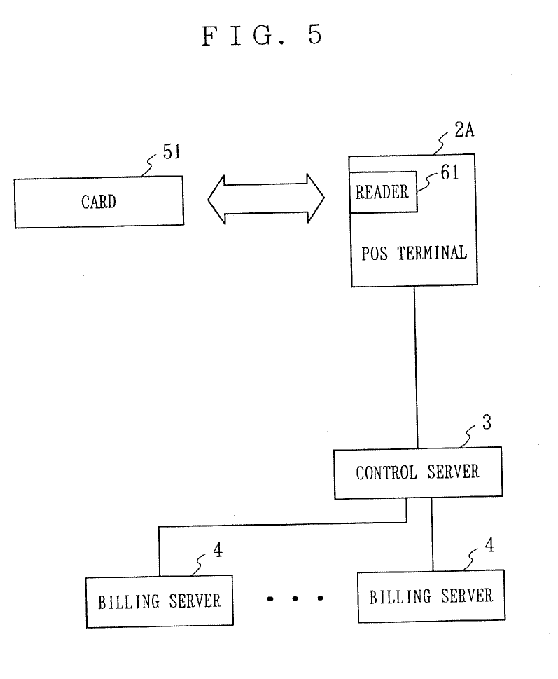

A charging system according to the second embodiment of the present invention utilizes a card 51 in place of the portable terminal device 1 in the charging system of the first embodiment. FIG. 5 is a block diagram showing the structure of the charging system according to the second embodiment of the present invention.

In FIG. 5, the card 51 is a portable device such as a magnetic card, an IC card or the like, which stores the customer ID of the user and the billing account information of any billing account of the plurality of billing accounts opened by the user, in which the billing account information is rewritable and the customer ID and the billing account information are readable. When the billing account information is stored in the card 51, for example, a specialized device (not shown) having a reader/writer for the card 51 may be separately used or the reader/writer for the card 51 may be connected to a personal computer to store the information by operating the personal computer.

Further, a POS terminal 2A is a terminal device installed in various shops, which has a register function of reading a barcode and the like provided on goods and the like and performing the settlement of the goods and the like, and performs transmission/reception of information of goods and the like to/from a center (not shown) and the like. The POS terminal 2A is also a terminal device reading by a reader 61 the customer ID and the billing account information outputted from the card 51 and transmitting to the control server 3 the charging amount to the user together with the information.

The control server 3 and the billing server 4 are the same as those in the first embodiment and the explanation thereof is not repeated.

Next, operation of each device in the above-described charging system is explained. In other words, a charging method according to the second embodiment of the present invention is explained.

In the charging system according to the second embodiment, the billing account information of the account selected by the user is stored in the card 51. Then, in payment of cost at a shop and the like, when the card 51 is inserted into the reader 61 of the POS terminal 2A, or comes into contact with it, or the like, the reader 61 reads the customer ID and the billing account information from the card 51. If personal identification information to the customer ID is necessary, for example, an input means is separately provided on the POS terminal 2A so that the user inputs the personal identification information to the input means. Then, the POS terminal 2A transmits the information and the charging amount to the control server 3.

Processing by the control server 3 is the same as that in the first embodiment and the explanation thereof is not repeated. Moreover, as in the first embodiment, the POS terminal 2A may be a terminal device and the like, which opens an online shop. The same modification examples as those in the first embodiment are also possible.

In the above-described second embodiment, the card 51 stores the customer ID of the user and the billing account information, but it is also suitable that the card 51 does not store them while the control server 3 transmits to the POS terminal 2 the plural pieces of billing account information corresponding to the customer ID of the user which are stored in the customer database 41, and the POS terminal 2 displays the list of billing accounts based on the plural pieces of billing account information transmitted from the control server 3, selects any of the plurality of billing accounts in response to the operation by the user to the input means (not shown) and transmits the selected billing account information to the control server 3.

As a result, it becomes unnecessary to store the billing account information in the card 51 and the manufacturing cost of the card 51 can be reduced.

As described above, according to the second embodiment, a cost for goods and/or service can be charged to a desired account among the plurality of accounts, as in the first embodiment. Further, as in the first embodiment, if the existing communication channel from the POS terminal 2 to the control server 3 is used, it is possible to realize the system at a low cost. In addition, the user need not input the charging amount, and so on.

Moreover, according to the above-described second embodiment, the card 51 is utilized which stores the customer ID of the user and the billing account information of any billing account of the plurality of billing accounts, in which the billing account information is rewritable and the identifier of the user and the billing account information are readable. As a result, by storing billing account information in accordance with purpose in the card previously, the payment of a cost can be also performed easily at a shop and the like.

Third Embodiment

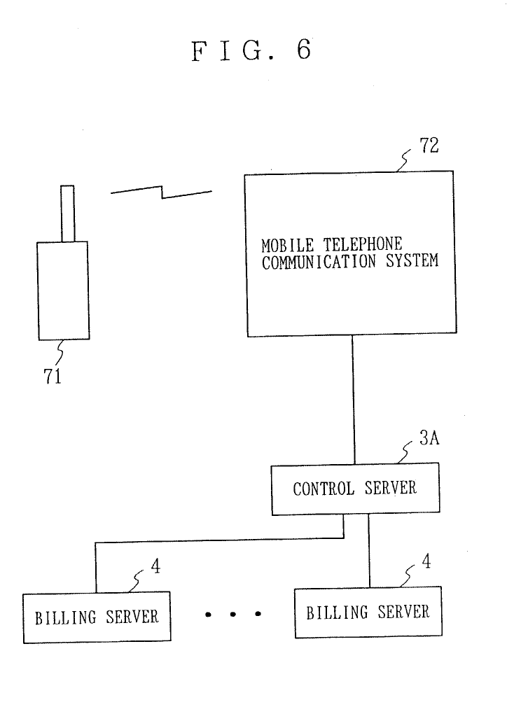

A charging system according to the third embodiment of the present invention charges a telephone call charge of a mobile telephone 71 as a portable device to a billing account to which a charge is charged in accordance with a call destination. FIG. 6 is a block diagram showing the structure of the charging system according to the third embodiment of the present invention.

In FIG. 6, the mobile telephone 71 is a PHS telephone, a portable telephone, and the like, classifying and storing a plurality of destination telephone numbers and, when a telephone call is made, transmitting information of a group to which a telephone number of the calling destination belongs as billing account information.

In addition, a mobile telephone communication system 72 is a system including a large number of base stations, exchanges, and the like, establishing a line to a telephone connected to a public telephone network, another mobile telephone and so on, to enable telephone call and data communication, and extracting the billing account information transmitted by the mobile telephone 71.

Further, a control server 3A is a server device connected to the mobile telephone communication system 72 and receiving the billing account information transmitted by the mobile telephone 71 from the mobile telephone communication system 72.

The inner structure of the control server 3A is the same as that of the control server 3 in the first embodiment, but the customer database 41 stores a telephone number of the mobile telephone 71 as a customer ID of the user, and the plural pieces of billing account information corresponding to the user by relating them to a group to which a destination telephone number belongs.

In addition, when a telephone call is made by the mobile telephone 71, the control means 43 of the control server 3A identifies the user from the telephone number of the mobile telephone 71, and determines a billing account to charge a telephone call charge of the call, based on the billing account information (that is, information of a group to which a telephone number of the calling destination belongs) transmitted from the mobile telephone 71 via the mobile telephone communication system 72.

The billing server 4 is the same as that in the first embodiment and the explanation thereof is not repeated.

Next, operation of each device in the above-described charging system is explained. In other words, a charging method according to the third embodiment of the present invention is explained.

When the user operates the mobile telephone 71 to make a telephone call, the telephone number thereof is first transmitted from the mobile telephone 71 to the mobile telephone communication system 72 as an identifier of the user together with information designating a group to which a telephone number of the calling destination belongs.

The mobile telephone communication system 72 extracts the information of the telephone number and the group, regards a charge for the telephone call as a charging amount and transmits to the control server 3A the telephone number of the mobile telephone 71, the information designating the group to which the telephone number of the calling destination belongs, and the charging amount when the telephone call ends.

The control server 3A searches the customer database 41 to identify the user based on the telephone number, selects an account designated by the billing account information (information such as a financial institution, a type of an account, and an account number) related to the group to which the telephone number of the calling destination belongs from among the accounts opened and registered by the user, as an account to be charged, and transmits the billing account information to the billing server 4. Incidentally, if classification is not performed in advance, the charge may be charged to the main account. In addition, the charging amount to each billing account may be summarized and charged collectively, for example, by each month.

As charged in the above-described way, for example, a destination telephone number to call on business is set to belong to a first group and a destination telephone number to call for private purpose to a second group in advance, and billing accounts for the first group and the second group are separated.

Incidentally, in the above-described third embodiment, the control server 3A is located outside the mobile telephone communication system 72, but, naturally, the control server 3A may be provided inside the mobile telephone communication system 72.

As described above, according to the third embodiment, a cost for goods and/or service can be charged to a desired account among the plurality of accounts, as in the first embodiment.

Further, according to the above-described third embodiment, the mobile telephone 71 classifies and stores the plurality of destination telephone numbers and, when a telephone call is made, transmits information of a group to which a telephone number of the calling destination belongs as billing account information; the customer database 41 of the control server 3A stores the telephone number of the portable device as an identifier of the user and the plural pieces of billing account information corresponding to the user by relating them to a group to which the destination telephone number belongs; the control means 43 of the control server 3A identifies the user from the telephone number of the mobile telephone 71 when a telephone call is made by the mobile telephone 71, and determines a billing account to charge the charge for the telephone call, based on the billing account information corresponding to the group to which the telephone number of the calling destination belongs, transmitted from the mobile telephone 71. As a result, the telephone call charge of the mobile telephone 71 can be charged to a billing account in accordance with the destination automatically.

Forth Embodiment

A charging system according to the forth embodiment of the present invention is the same as the charging system according to the third embodiment, in which the billing account information is stored in the mobile telephone 71, the mobile telephone 71 selects billing account information in accordance with the destination telephone number and transmits the selected billing account information to the control server 3A via the mobile telephone communication system 72, and the control server 3A determines a billing account to be charged by the billing account information.

In other words, when the user makes a telephone call, the billing account information related to a telephone number of the calling destination is transmitted from the mobile telephone 71 to the mobile telephone communication system 72 and supplied to the control server 3A.

Incidentally, in transmitting the billing account information, security of the communication channel is secured, for example, with cryptographic technology and the like.

It is suitable that the mobile telephone 71 classifies and stores the plurality of destination telephone numbers as well as stores the billing account information of the plurality of billing accounts, relates a group of the destination telephone number to any of the plurality of billing accounts opened by the user and, when a telephone call is made, transmits billing account information of the billing account related to a group to which a telephone number of the calling destination belongs.

In this case, for example, the mobile telephone 71 stores a telephone number A and a telephone number B by relating them to a group “business” and also stores billing account information C of a billing account to charge a business cost by relating it to a group “business”. Then, when a telephone call is made to the telephone number A, the mobile telephone 71 transmits the billing account information C which is related to the group “business”, of the telephone number A.

It should be noted that the customer database 41 is not particularly necessary for the control server 3A in the forth embodiment.

As described above, according to the forth embodiment, a telephone call charge of the mobile telephone 71 can be charged to a desired account among the plurality of accounts, as in the third embodiment. In addition, since the billing account information is registered in the mobile telephone 71, the user can edit the billing account information easily by operating the mobile telephone 71 freely.

Further, according to the above-described forth embodiment, if the billing account information is related to the group of the destination telephone number, charging destinations are separated based on groups which are easy for the user to recognize, for example, business and private.

In the above-described first, second and forth embodiments, from any of the portable terminal device 1, the card 51 and the mobile telephone 71 to the control server, the billing account information is transmitted in the same form as that in the customer database 41, but an identifier designating respective billing account information may be transmitted as billing account information. In this case, the corresponding relation between the identifier and the billing account information is stored in advance in the customer database 41 and the billing account information is specified from the identifier based on the corresponding relation. As a result, billing account information itself is not transmitted and the possibility of the leakage of the account information is reduced.

Industrial Availability

In a charging system according to the present invention, a cost for goods and/or service can be charged to a desired account among a plurality of accounts.

1. A charging system for charging a cost to an account opened by a user, comprising:
a portable device at least storing an identifier of the user and outputting billing account information of any billing account of a plurality of billing accounts; and
a control server including a storage means for storing the identifier of the user and plural pieces of billing account information corresponding to the identifier and a charging means for identifying the user by the identifier obtained from said portable device and for determining a billing account to be charged by the billing account information obtained from said portable device.

2. A charging system according to claim 1, further comprising:
a terminal device receiving the identifier and the billing account information from said portable device and transmitting to said control server,
wherein said terminal device transmits a charging amount to the user together with the identifier and the billing account information to said control server, and
wherein said control server charges the charging amount to the determined billing account to be charged.

3. A charging system according to claim 1 or claim 2,
wherein said portable device is a portable terminal device having a portable device side storage means for storing the identifier of the user, a display means for displaying a list of the billing accounts based on the plural pieces of billing account information, an input means for receiving operation of the user, a selection means for selecting any of the plurality of billing accounts in response to the operation of the user to the input means, and an output means for outputting billing account information of the billing account selected by the selection means.

4. A charging system according to claim 3,
wherein the portable device side storage means of said portable device stores the plural pieces of billing account information of the plurality of billing accounts owned by the user.

5. A charging system according to claim 3,
wherein said control server transmits the plural pieces of billing account information corresponding to the identifier of the user which are stored in the storing means to said portable device, and
wherein the display means of said portable device displays the list of the billing accounts based on the plural pieces of billing account information which are transmitted from said control server.

6. A charging system according to claim 1 or claim 2,
wherein said portable device is a card storing the identifier of the user and billing account information of any billing account of the plurality of billing accounts, the billing account information being rewritable, and the identifier of the user and the billing account information being readable.

7. A charging system according to claim 2,
wherein said portable device is a card storing the identifier of the user, the billing account information being rewritable and the identifier of the user being readable,
wherein said control server transmits the plural pieces of billing account information corresponding to the identifier of the user which are stored in the storage means to said terminal device, and
wherein said terminal device displays the list of the billing accounts based on the plural pieces of billing account information which are transmitted from said control server, selects any of the plurality of billing accounts in response to operation of the user, and transmits the selected billing account information to said control server.

8. A charging system according to claim 1,
wherein said control server regards a predetermined billing account as a billing account to be charged when a billing account is not specified.

9. A charging system according to claim 1,
wherein said portable device stores corresponding relation between a type of goods and/or service which the user purchases and any of the billing account information and, when goods and/or service is purchased and a cost is incurred by the user, outputs billing account information which has corresponding relation with the goods and/or service.

10. A charging system according to claim 1,
wherein said portable device is a mobile telephone classifying and storing a plurality of destination telephone numbers and, when a telephone call is made, outputting information of a group to which a destination telephone number of the telephone call belongs as the billing account information,
wherein the storage means of said control server stores a telephone number of said portable device as the identifier of the user as well as stores the plural pieces of billing account information corresponding to the user which relate to the groups to which the destination telephone numbers belong, and
wherein the charging means of said control server identifies the user from the telephone number of said portable device when the telephone call is made by said portable device, and determines a billing account to charge a charge for the telephone call, based on the billing account information corresponding to the group to which the telephone number of the calling destination belongs transmitted from said portable device.

11. A charging method for charging a cost to an account opened by a user, comprising:
a step where a portable device transmits an identifier of the user and billing account information of any billing account of a plurality of billing accounts, and
a step of identifying the user by the identifier transmitted from the portable device based on an identifier of the user and plural pieces of billing account information related to the identifier which are stored in a customer database of a control server in advance, and determining a billing account to be charged from among the plurality of billing accounts opened by the identified user by the billing account information transmitted from the portable device.

12. A portable device of a user opening an account to charge a cost, comprising:
a portable device side storage means for at least storing an identifier of the user; and
an output means for outputting billing account information of any billing account of a plurality of billing accounts opened by the user.

13. A control server comprising:
a storage means for storing an identifier of a user who opens an account to charge a cost and plural pieces of billing account information corresponding to the identifier; and
a charging means for identifying the user by an identifier of the user obtained from a portable device of the user, with reference to the identifier of the user and the plural pieces of billing account information in the storage means, and determining a billing account to be charged by billing account information obtained from the portable device of the user.

14. A charging system for charging a cost to an account opened by a user, comprising:
a mobile telephone storing a plurality of destination telephone numbers and plural pieces of billing account information of a plurality of billing accounts opened by the user by relating each destination telephone number to any of the billing account information respectively and, when a telephone call is made, outputting billing account information related to a telephone number of the calling destination; and
a control server determining a billing account to be charged by the billing account information obtained from the mobile telephone.

15. A charging system for charging a cost to an account opened by a user, comprising:
a mobile telephone classifying and storing a plurality of destination telephone numbers, relating a billing account opened by the user to each of a plurality of groups respectively, storing plural pieces of billing account information of a plurality of billing accounts, and, when a telephone call is made, outputting billing account information of a billing account related to a group to which a telephone number of the calling destination belongs; and
a control server determining a billing account to be charged by the billing account information obtained from the mobile telephone.
